(19) United States
(12) Patent Application Publication
(10) Pub. No.: US 2008/0314608 A1
(43) Pub. Date: Dec. 25, 2008

(54) Linearly Driven and Air-Cooled Boring and/or Percussion Hammer

(75) Inventors: Rudolf Berger, Grunwald (DE); Wolfgang Schmid, Munchen (DE); Michael Steffen, Munchen (DE); Otto W. Stenzel, Herrsching (DE)

Correspondence Address: BOYLE FREDRICKSON S.C., 840 North Plankinton Avenue, MILWAUKEE, WI, 53203, US

(73) Assignee: WACKER CONSTRUCTION EQUIPMENT AG, MUNCHEN (DE)

(21) Appl. No.: 11/997,635

(22) PCT Filed: Jul. 23, 2006
(86) PCT No.: PCT/EP2006/007394

§ 371 Date: Jun. 19, 2008

(30) Foreign Application Priority Data
Aug. 3, 2005 (DE) 10 2005 036 560.4

(51) Int. Cl. B25D 11/06; B25D 17/20

(52) U.S. Cl. 173/132; 173/117; 173/212

(57) ABSTRACT

A boring and/or percussion hammer comprises an electrodynamic linear drive and a pneumatically damped percussion mechanism which is provided with a drive piston driven by the linear drive during the reciprocating movement thereof, an impact piston and a pneumatic spring arranged between the drive and impact pistons. An air-supply device comprises a pumping element, which is linearly forth and back movable for generating airflow. The pumping element is connected to the drive piston in such a way that the movement thereof is transmitted to said pumping element, thereby the cooling air is transported by an air channel for cooling heat generated elements.

### BACKGROUND OF THE INVENTION

1. Field of the Invention

According to the preamble of claim 1, the present invention relates to a boring and/or percussion hammer having an electrodynamic linear drive.

2. Description of the Related Art

Boring and/or percussion hammers (referred to as “hammers” hereinafter) are standardly driven by electric motors in which a rotor rotates a drive shaft. In order to cool the motor and the percussion mechanism provided in the hammer, the rotor is usually coupled to a ventilator wheel of a blower that produces a cooling air stream. The rotational movement of the rotor is thus used to drive a radial or axial ventilator wheel in a simple manner.

From DE 102 04 861 A1, a pneumatic spring hammer mechanism is known in which a drive piston is capable of being driven by an electrodynamic linear drive. The drive piston is coupled to a runner of the linear drive, so that the linear back-and-forth movement of the runner is transmitted to the drive piston. As is standard in pneumatic spring hammer mechanisms, the movement of the drive piston is in turn transmitted via an air spring to a percussion piston that strikes a tool end or an intermediately connected header in a known manner.

In such a percussion mechanism having a linear drive, as a result of the design there are no rotating parts. Correspondingly, a rotary blower cannot be connected in the simple manner made possible when there is a rotational drive. However, during operation of the hammer the linear drive and the pneumatic spring hammer mechanism produce heat that has to be dissipated.

In U.S. Pat. No. 1,723,607 A, a percussion hammer is indicated that has a percussion element that is immediately linearly driven electrodynamically. The percussion element and a drive element form a functional unit and are connected to one another rigidly, or with a positive coupling. Chambers situated before and after the percussion or drive element are connected to themselves and to the surrounding environment via ducts. When the percussion mechanism is in operation, the volumes before and after the percussion element change in opposite directions. Due to the connection of both chambers, air is exchanged between the two chambers.

### OBJECT OF THE INVENTION

The object of the present invention is to indicate a boring and/or percussion hammer having an electrodynamic linear drive in which a sufficient air cooling of the heat-producing components is ensured.

According to the present invention, this object is achieved by a boring and/or percussion hammer as recited in claim 1. Advantageous embodiments of the present invention indicated in the dependent claims.

A boring and/or percussion hammer (below: hammer) according to the present invention has an air-conveying device that has a pump element that can be moved back and forth in order to produce a cooling air stream. The pump element is coupled to the drive element and/or to the percussion element of the percussion mechanism in such a way that the movement of the drive element and/or of the percussion element is capable of being transmitted to the pump element.

The drive element can, e.g. in a pneumatic spring hammer mechanism, be formed by a drive piston. It is moved back and forth in a known manner by the linear drive. According to the present invention, the pump element is advantageously coupled to the drive element, so that it must also moved back and forth in a linear fashion. With the aid of this oscillating linear movement, a cooling air stream can be produced that is routed past the components that are to be cooled. The linearly driven air-conveying device enables the production of a cooling air stream without having to provide a rotary fan.

In an advantageous specific embodiment of the present invention, the drive element is connected to a runner of the linear drive. In particular, it is advantageous if the drive element bears the runner or is essentially formed completely by the runner, so that the runner simultaneously takes over the function of the drive element.

The linear motor can be a switched reluctance motor (SR motor) and has in the area of movement of the runner a plurality of drive coils (stators) that are connected in a manner corresponding to the desired movement of the drive element. It is to be noted that in the context of the present invention an electrodynamic drive, e.g. in the form of a single electromagnetic coil that acts as the drive coil for the drive element, is also regarded as a linear motor. The return movement of the drive element can then take place e.g. via a helical spring or the like. The important thing is that the drive element be connected tightly to the runner.

In an advantageous specific embodiment of the present invention, the coupling device has at least one stop that acts between the drive element and the percussion element. The stop ensures a positively coupled transmission of the movement of the drive element to the percussion element, which is then compelled to follow the movement of the drive element.

In a preferred specific embodiment, the coupling device has an elastic element that acts in at least one direction between the drive element and the percussion element. In this way, it is possible for the stop described above to be realized so as to be elastic, e.g. through an elastic element held on the stop or an elastic coating. Alternatively, the elastic element can also be formed by an air spring explained in more detail below, if the percussion mechanism is realized as a pneumatic spring hammer mechanism.

In a particularly advantageous specific embodiment of the present invention, the drive element, the runner, and the pump element form a constructive unit. In particular, these constructive elements can be connected to one another in one piece, so that the movement of the runner can be transmitted without loss to the drive element and to the pump element. The drive element and the pump element are then compelled to follow the movement of the runner.

In a specific embodiment of the present invention, the movement of the drive element can be transmitted to the pump element via a mechanical coupling, a hydraulic coupling, or a pneumatic coupling. For example, between the drive element and the pump element there may run a Bowden cable or a hydraulic line in order to transmit the movement of the drive element to the pump element with as little loss as possible. In this variant, it is not necessary for the drive element and the runner to form a constructive unit with the pump element. Rather, the pump element can then also be situated at a different location in the hammer.

In a particularly advantageous further development, the pump element is situated in an area of the hammer that is decoupled from the percussion mechanism in terms of vibration. The percussion mechanism and the linear drive produce a significant amount of vibration due to the oscillating movement of the movable elements and the impact action of the percussion element. From the prior art, many solution strategies are known for isolating these vibrations e.g. from a handle of the hammer, and to protect the operator from damaging vibrations. Correspondingly, in almost all hammers it is known to decouple at least a partial area from the percussion mechanism in terms of vibration. The situation of the pump element in this vibration-decoupled area has the advantage that the pump element and the other components of the air-conveying device are subject to less mechanical stress, so that more reliable functioning can be achieved.

Preferably, the runner is essentially cylindrical or hollow-cylindrical. Alternatively, it can also have at least one plate-shaped or sword-like element that extends in the axial direction. This plate-shaped element, fashioned for example as a continuation of the drive element, extends into the stator area in order to achieve the desired drive effect.

In a particularly advantageous specific embodiment of the present invention, the air-conveying device has a pump chamber and an air duct, the pump element being capable of being moved back and forth in the pump chamber and the pump chamber being capable of being brought into connection with the surrounding environment at least at times via the air duct. Through the movement of the pump element in the pump chamber, a kind of air pump is formed that functions in a manner similar to a bicycle pump (piston pump). Due to the coupling of the pump chamber with the surrounding environment via the air duct, it is possible for fresh cool air to be brought into the pump chamber from the surrounding environment, or for heated air to be emitted to the surrounding environment.

Correspondingly, it is particularly advantageous if the air duct is situated in such a way that it runs past heat-producing components of the hammer, in particular along a part of a stator of the linear drive. An electrical current flows through the stator, and correspondingly contributes significantly to heat production. This heat can be conducted away from the stator via the cool air flowing through the air duct.

In a particularly advantageous specific embodiment of the present invention, the air duct has an intake duct that permits air to flow from the surrounding environment into the pump chamber. Correspondingly, the air duct can also have an outlet duct so that air can flow out of the pump chamber to the surrounding environment. While in a first variant, the ambient air is conveyed back and forth in the air duct, if the air duct is divided into an intake duct and an outlet duct a directed air flow can be achieved that always flows only in one direction. Correspondingly, cold air is supplied from the surrounding environment via the intake duct, while the heated air is emitted to the surrounding environment via the outlet duct.

In order to support the directed air flow, it is particularly advantageous if a check valve that permits air flow in only one direction is situated in the intake duct and/or in the outlet duct.

In an advantageous development of the present invention, a storage device is provided that stands in communicating connection with the outlet duct and that is used for the intermediate storage of at least some of the air flowing out via the outlet duct. The storage device ensures an equalization of the air pressure fluctuations that necessarily result from the movement of the pump element. Pressure peaks can be dismantled through a temporary storage of air by the storage device. If, in contrast, no air is supplied by the pump element, the storage device releases the air, thus providing for an essentially uniform stream of cooling air. For this purpose, it is useful that an elastic or spring-loaded element be provided in the storage device that modifies the size of a storage chamber dependent on the pressure of the air flow supplied by the pump element.

Preferably, a cross-section of the outlet duct downstream from the storage device is, smaller than a cross-section of the outlet duct upstream from the storage device. This makes it possible for the air stream conveyed by the pump element to reach the storage device in an unhindered fashion, in order to fill the storage device in as loss-free a manner as possible. The actual cooling air stream is then conducted away via the outlet duct having the smaller cross-section, this outlet duct being routed past the heat-producing components.

In order to support a directed air flow, a check valve can be situated in the outlet duct between the pump chamber and the storage device.

In a particularly advantageous specific embodiment of the present invention, the pump element is situated behind the drive element and the runner, seen in the direction of impact. Alternatively, the pump element can also be situated next to the percussion mechanism. Here it should be sought to situate the air-conveying device in the hammer housing in as space-saving a manner as possible in order not to increase the constructive volume, above all the length.

In a particularly preferred specific embodiment of the present invention, the percussion mechanism is formed by a pneumatic spring hammer mechanism. For this purpose, the drive element is fashioned as a drive piston and the percussion element is fashioned as a percussion piston, the coupling device having an air spring formed in a hollow space between the drive piston and the percussion piston. The air spring thus transmits, in a known manner, the drive movement of the drive piston to the percussion piston.

The coupling according to the present invention of a linear drive to an air-conveying device can be applied to all types of percussion mechanisms. In particular, the coupling according to the present invention is suitable for percussion mechanisms that are fashioned as pneumatic spring hammer mechanisms, and is thus suitable for known tube hammer mechanisms (drive piston and percussion piston having the same diameter), hollow piston percussion mechanisms (drive piston having a hollow space in which the percussion piston moves), or percussion mechanisms having a hollow percussion piston in which the drive piston moves.

In a particularly advantageous specific embodiment of the present invention, similar to a hollow piston percussion mechanism, the drive piston surrounds the percussion piston before and after the percussion piston, seen in the direction of impact, in such a way that the air spring is situated behind the percussion piston, and that a second air spring can be formed in front of the percussion piston, between the drive piston and the percussion piston. In this type of percussion mechanism, there is thus a double air spring that on the one hand produces the forward movement of the percussion piston and on the other hand support a return movement of the percussion piston.

In an advantageous specific embodiment of the present invention, a cross-sectional surface of the pump element that acts to produce the air flow is greater than a cross-sectional surface of the drive piston that acts on the air spring. Depending on the design of the linear drive and of the pneumatic spring hammer mechanism, in some circumstances a significant amount of heat may be released that must be conducted away. For this purpose, a correspondingly large cooling air stream is required. In order for the air-conveying device to be able to produce this cooling air stream, the pump element must have a correspondingly large cross-sectional surface. Of course, the pump element may also be replaced by a plurality of individual pump elements that are individually smaller in their dimensions but that achieve a sufficiently large effective cross-sectional surface through their coupling to the runner, and thus their working together. Correspondingly, the term “pump element” relates only to the function, not to the concrete realization.

These and additional advantages and features of the present invention are explained in more detail below on the basis of examples, with the assistance of the accompanying Figures.

### BRIEF DESCRIPTION OF THE DRAWINGS

FIG. 1 shows a schematic representation of a section through a hammer according to the present invention, in a first specific embodiment of the present invention;

FIG. 2 shows a schematic representation of a second specific embodiment of the present invention;

FIG. 3 shows a schematic representation of a third specific embodiment of the present invention;

FIG. 4 shows a schematic representation of a fourth specific embodiment of the present invention;

FIG. 5 shows a schematic representation of a fifth specific embodiment of the present invention;

FIG. 6 shows a schematic representation of a sixth specific embodiment of the present invention;

FIG. 7 shows a schematic representation of a seventh specific embodiment of the present invention; and

FIG. 8 shows a section through a schematic representation of a percussion mechanism according to an eighth specific embodiment of the present invention.

### DETAILED DESCRIPTION OF THE PREFERRED EMBODIMENT

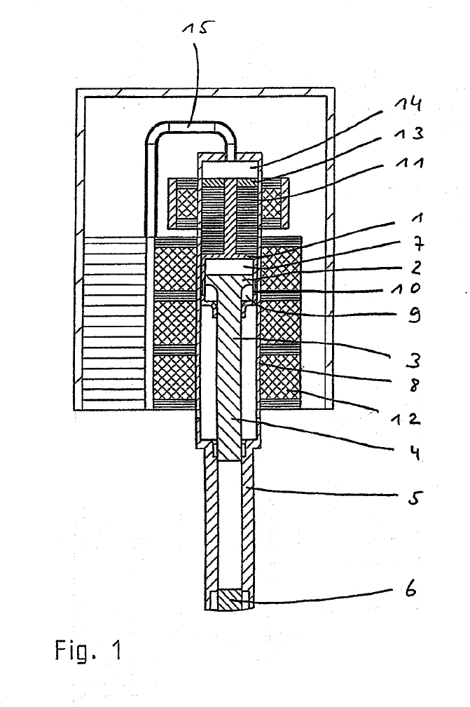

FIGS. 1 to 8 show various specific embodiments of the hammer according to the present invention in a greatly simplified sectional representation. In particular, known components such as e.g. handles and electrical terminals are omitted, because they do not relate to the present invention.

FIG. 1 shows a first specific embodiment of the present invention having a pneumatic spring hammer mechanism driven by an electrodynamic linear drive.

The pneumatic spring hammer mechanism has, as drive element, a drive piston 1 that surrounds a piston head 2 of a percussion piston 3 that acts as a percussion element. Shaft 4 of percussion piston 3 runs in a percussion piston guide 5, and can, in its frontmost position, strike a tool end 6. Instead of tool end 6, an intermediate header can also be provided in a known manner.

Between drive piston 1 and percussion piston 3, a hollow space is formed in which a first air spring 7 acts as a coupling device. When there is a forward movement of drive piston 1, which is capable of axial back-and-forth motion in a percussion mechanism housing 8, a pressure builds up in first air spring 7 that drives percussion piston 3 forward, so that it can finally strike tool end 6.

When there is a backward movement of drive piston 1, in first air spring 7 there arises a partial vacuum that suctions percussion piston 3 back. The backward movement of percussion piston 3 is also supported by the impact reaction at tool end 6. In addition, seen in the direction of impact, in front of piston head 2 a second air spring 9 is formed that also acts as a coupling device and that acts during the return movement of drive piston 1. It also supports the return movement of percussion piston 2.

In order to compensate air losses in pneumatic springs 7, 9, and in order to support the movement of drive piston 1 and of percussion piston 3, various air openings and air ducts are provided, such as a plurality of air equalizing pockets 10. Their functioning is known from the prior art, so that a more detailed description is not necessary here.

The oscillating linear back-and-forth movement of drive piston 1 is brought about by an electrodynamic linear drive. For this purpose, drive piston 1 is coupled to a runner 11 of the linear drive. Runner 11 can be formed by a plurality of electroplates layered one over the other, and is moved back and forth by alternating magnetic fields produced by a stator 12 of the linear drive. The functioning of such a linear drive is known and is described in, for example, DE 102 04 861 A1. The linear motor can be e.g. a reluctance motor having an external stator.

In the example shown in FIG. 1, runner 11 and drive piston 1 form a one-piece unit.

Directly on runner 11, a pump element is fashioned in the form of a pump piston 13 that is capable of back-and-forth movement in a pump chamber 14. Because pump piston 13 is connected in one piece to runner 11 and to drive piston 1, pump piston 13 is compelled to follow the movement of runner 11. Through its back-and-forth movement, pump piston 13 produces an excess pressure or a partial vacuum in pump chamber 14.

Pump chamber 14 is connected to the surrounding environment via an air duct 15. Air duct 15 is situated in the hammer in such a way that it is routed past at least some of the heat-producing components (here in particular stator 12), as is shown in FIG. 1. Pump piston 13, pump chamber 14, and air duct 15 form an air-conveying device according to the present invention.

If runner 11 moves downward together with drive piston 1 and pump piston 13, a partial vacuum is produced in pump chamber 14, so that air flows from the surrounding environment into pump chamber 14 via air duct 15. When there is a return movement of runner 11 with drive piston 1 and pump piston 13, the now-heated air is pressed out of pump chamber 14 and air duct 15. In the next cycle, fresh cooling air is again suctioned in. In this way, an effective cooling can be achieved in air duct 15.

The pump element according to the present invention is depicted as cylindrical, on the basis of pump piston 13. Of course, the pump element can also have arbitrary other shapes, and can be formed for example as a prismatic plate.

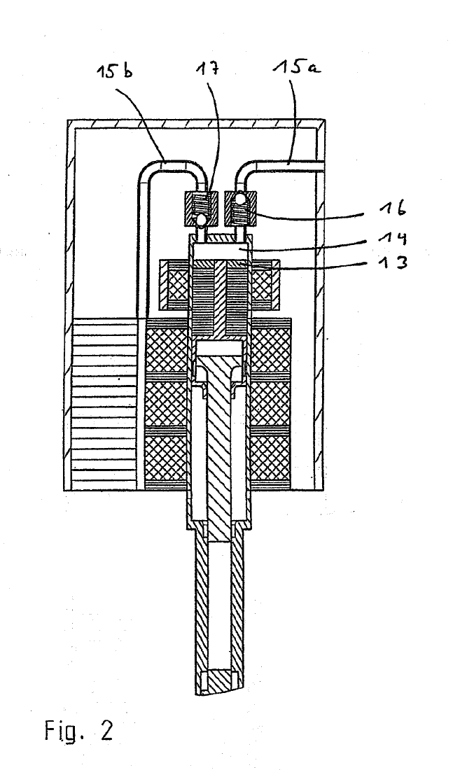

FIG. 2 shows, analogous to FIG. 1, a second specific embodiment of the present invention. Identical components have been assigned identical reference characters. In order to avoid repetition, only the differences between the second and the first specific embodiment are explained in the following.

In the second specific embodiment of the present invention, air duct 15 is divided into an intake duct 15a and an outlet duct 15b. Via intake duct 15a, air can flow into pump chamber 14 from the surrounding environment when pump piston 13 moves downward. When there is a return movement of pump piston 13, the air from pump chamber 14 is emitted to the surrounding environment via outlet duct 15b.

In order to ensure a directed air flow, an inlet check valve 16 is situated in intake duct 15a and an outlet check valve 17 is situated in outlet duct 15b. The check valves 16, 17 shown in FIG. 2 are fashioned as spring-loaded balls. Of course, other types of check valve may also be used. Thus, in the normal case it is sufficient to fashion the check valves with the aid of a rubber element fastened at one side that is lifted off from a valve opening when there is a flow from one direction, and is pressed against the valve opening, thus closing it, when the flow is in the other direction.

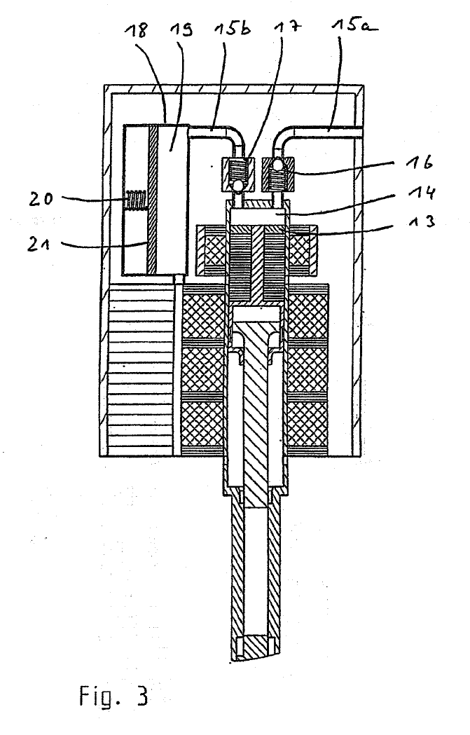

FIG. 3 shows a third specific embodiment of the present invention that differs from the second specific embodiment shown in FIG. 2 in that a storage device 18 is provided in the area of outlet duct 15b. Storage device 18 is used to equalize air pressure fluctuations that, in particular in outlet duct 15b, result necessarily from the oscillating movement of pump piston 13. Storage device 18 is able to eliminate pressure peaks by enlarging a storage space 19 against the action of a spring-elastic element 20. As soon as the pump pressure resulting from pump piston 13 decreases, spring-elastic element 20 causes storage space 19 to become smaller, so that a flow of air through the downstream part of outlet duct 15b is maintained.

In the example shown in FIG. 3, spring-elastic element 20 is fashioned as a helical screw that presses against a movable wall 21. Of course, this system can also be replaced by, for example, a rubber membrane.

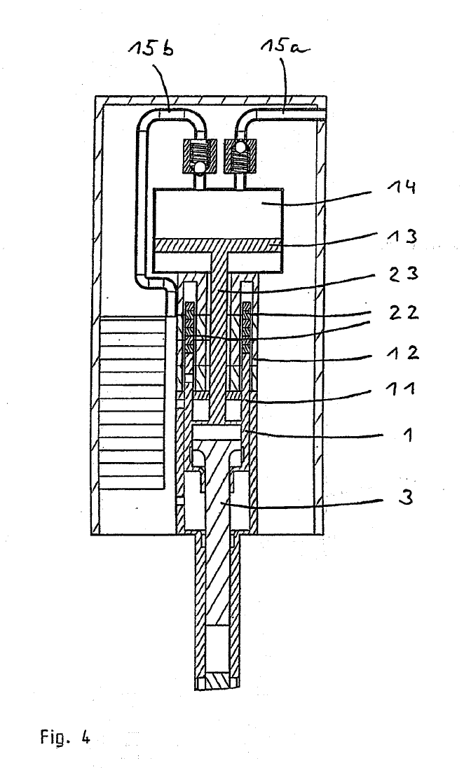

FIG. 4 shows a fourth specific embodiment of the present invention, analogous to the second specific embodiment shown in FIG. 2.

However, in this fourth specific embodiment the runner is formed by two sword-like plate prolongations 22 that are capable of being moved back and forth in a correspondingly shaped stator 12.

Pump piston 13 is connected to drive piston 1 via a piston rod 23.

In this design, the cross-sectional surface of pump piston 13 and of pump chamber 14 can be made larger, because these components are situated behind the linear drive.

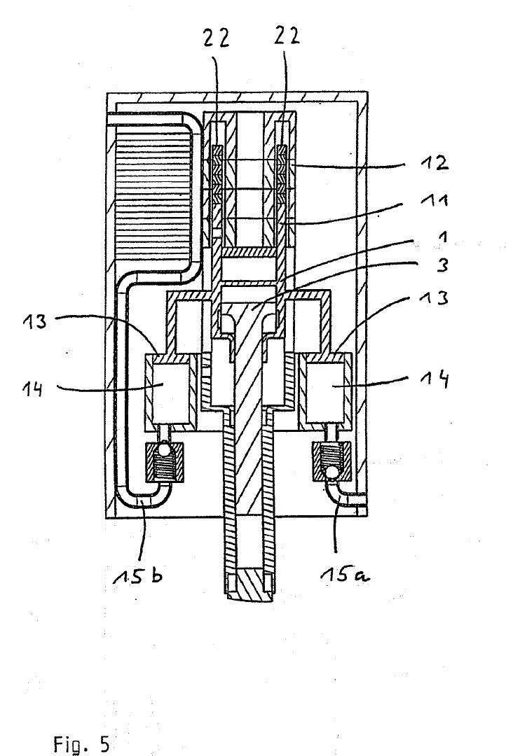

FIG. 5 shows a fifth specific embodiment of the present invention in which the air-conveying device is situated axially alongside the pneumatic spring hammer mechanism, thus saving space.

For this purpose, pump piston 13 and pump chamber 14 surround the pneumatic spring hammer mechanism in annular fashion. However, two or more pump pistons 13 may also be provided that are capable of being moved in respectively allocated pump chambers 14. The function of pump piston 13 can thus be achieved using a plurality of individual pistons.

In the specific embodiment shown in FIG. 5, outlet duct 15b is also routed past stator 12, in which runner 13, with plate prolongations, can be moved. Of course, instead of plate prolongations 22 it is also possible to use a cylindrical runner 13 as shown in FIGS. 1 to 3.

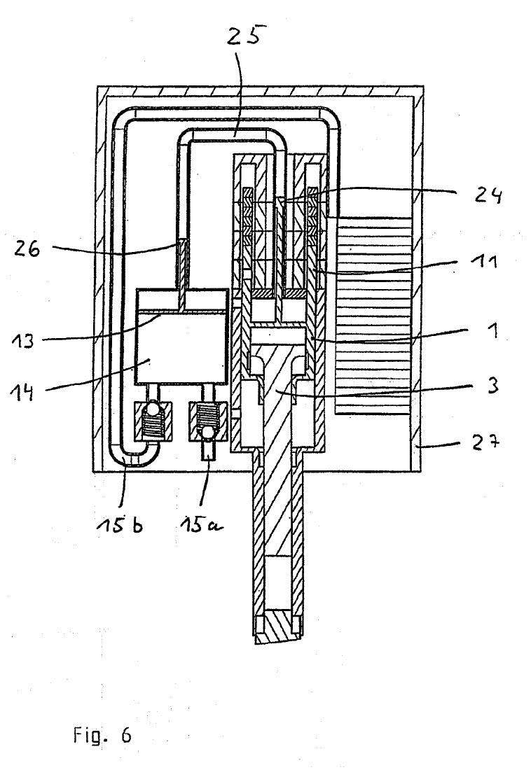

FIG. 6 shows a sixth specific embodiment of the present invention. Here, the air-conveying device with pump piston 13 and pump chamber 14 is provided separately from drive piston 1 and runner 11.

On the unit formed by drive piston 1 and runner 11, a hydraulic piston 24 is fashioned that, via a hydraulic line 25, conveys hydraulic fluid to a hydraulic shaft 26 that is connected to pump piston 13. Correspondingly, pump piston 13 follows the movement of drive piston 1 and runner 11 essentially without loss. When there is a percussion movement of drive piston 1, hydraulic piston 24 is lowered, so that hydraulic shaft 26 is suctioned upward due to the partial vacuum in hydraulic line 25. As a result of the thus compelled upward movement of pump piston 13, air flows into pump chamber 14 via suction duct 15a (here relatively short), and is ejected via outlet duct 15 when there is a return movement of drive piston 1, with a correspondingly transmitted movement to pump element 13. The return movement can be supported by an additional spring.

The mechanical transmission of the movement of drive piston 1 to pump piston 13 can also take place with the aid of a movable guided succession of balls in a pipe or hose connection. Pump piston 13 must then be compelled into its initial position using a spring.

In the sixth specific embodiment, the constructive decoupling of the air-conveying device from the linear drive and from the pneumatic spring hammer mechanism makes it possible for the air-conveying device to be situated in the hammer so as to be decoupled in terms of vibration. For example, it is possible to fasten the air-conveying device to a housing cover 27 that is decoupled in terms of vibration relative to the linear drive and to the pneumatic spring hammer mechanism.

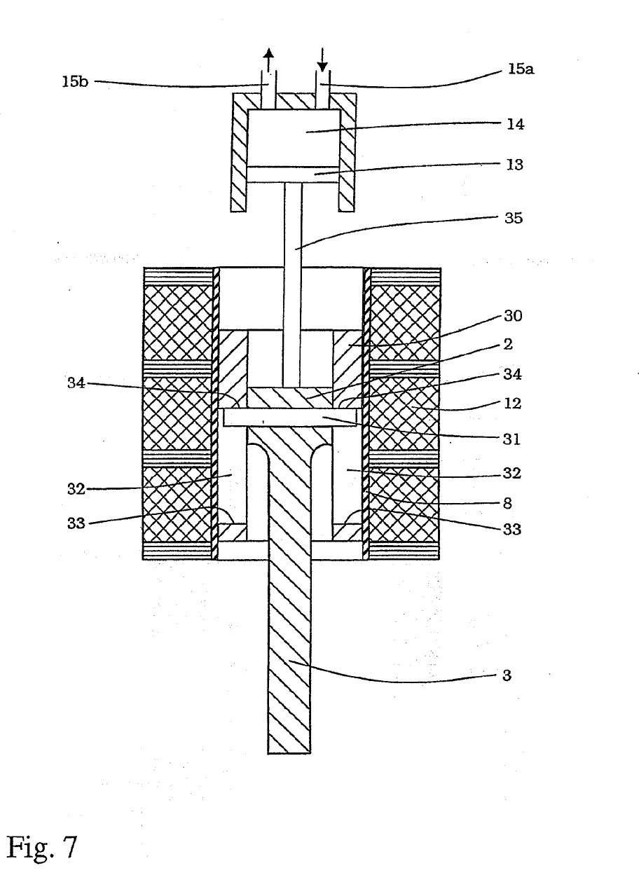

FIG. 7 shows a schematic section through a seventh specific embodiment of the present invention. In contrast to the pneumatic spring hammer mechanisms described above on the basis of FIGS. 1 to 6, the seventh specific embodiment according to FIG. 7 relates to a percussion mechanism in which the energy for the percussion movement cannot be transmitted by an air spring. Correspondingly, this percussion mechanism cannot be designated a pneumatic spring hammer mechanism.

The percussion mechanism is driven by an electrodynamic linear drive, in a manner similar to the pneumatic spring hammer mechanisms described above. It has a drive unit 30 that combines the functions of a drive element and a runner of the linear drive. Drive unit 30 is shown only schematically in FIG. 7. Thus, for example the construction of the runner is not shown in detail. However, the details described above for runner 11 (e.g. in FIG. 1) apply to the runner here as well.

Analogous to the manner described above, drive unit 30 is capable of being moved back and forth in a tube-shaped percussion mechanism housing 8, this movement being brought about by stator 12.

Drive unit 30 has a sleeve-type construction, and has in its interior a hollow area in which percussion piston 3, which forms a percussion element, can be moved back and forth. Percussion piston 3 then strikes the tool (not shown in FIG. 7) in a known manner.

In order to transmit the movement of drive unit 30 to percussion piston 3, a coupling device is provided. The coupling device has a dog 31 that is borne by percussion piston 3, in particular by piston head 2 of percussion piston 3, that is capable of being moved back and forth in recesses of drive unit 30 in the working direction of the percussion mechanism. Dog 31 can be formed for example by a cross-bolt that passes through piston head 2 of percussion piston 3, as is shown in FIG. 7.

The recesses in drive unit 30 are formed by two longitudinal grooves 32 that run axially and that penetrate the wall of hollow cylindrical drive unit 30.

On the end surfaces of longitudinal grooves 32, lower stops 33 and upper stops 34 are formed that limit the longitudinal movement of dog 31 in longitudinal grooves 32.

When there is a back-and-forth movement of drive unit 30, percussion piston 3 is thus guided in a compulsory manner via the respective stops 33, 34, as well as via dog 31. When drive unit 30 moves forward (downward in FIG. 7) in the direction of the tool (working direction), upper stops 34 press dog 31 with percussion piston 3 downward; here the percussion piston should fly free shortly before striking the tool or the intermediately connected header in order to avoid reaction effects that could damage drive unit 30 and dog 31. During the subsequent return movement of drive unit 30, lower stops 33 come into contact with dog 31 and pull percussion piston 3 (which is also recoiling from the tool) back, opposite the working direction. After this, the work cycle is repeated in that drive unit 30, with upper stops 34, accelerates percussion piston 3 again against the tool.

In this specific embodiment, the coupling device is therefore formed not by an air spring but rather by longitudinal grooves 32, stops 33, 34, and dog 31. Of course, the described design is provided only for the purposes of explanation. Numerous other possible designs for transmitting the movement of drive unit 30 to percussion piston 3 are known to those skilled in the art.

Piston head 2 of percussion piston 3 is positively coupled to a pump piston 13 via a piston rod 35. Pump piston 13 is capable of being moved back and forth in a pump chamber 14.

Via intake duct 15a, air from the surrounding environment can flow into pump chamber 14 in the manner described above when pump piston 13 moves downward. When there is a return movement of percussion piston 3 with positively coupled pump piston 13, air from pump chamber 14 is emitted to the surrounding environment via outlet duct 15b.

The additional functions, in particular the routing of the cooling air stream and the design of the air-conveying device, including check valves that may be present, can be realized in a manner analogous to the specific embodiments described above.

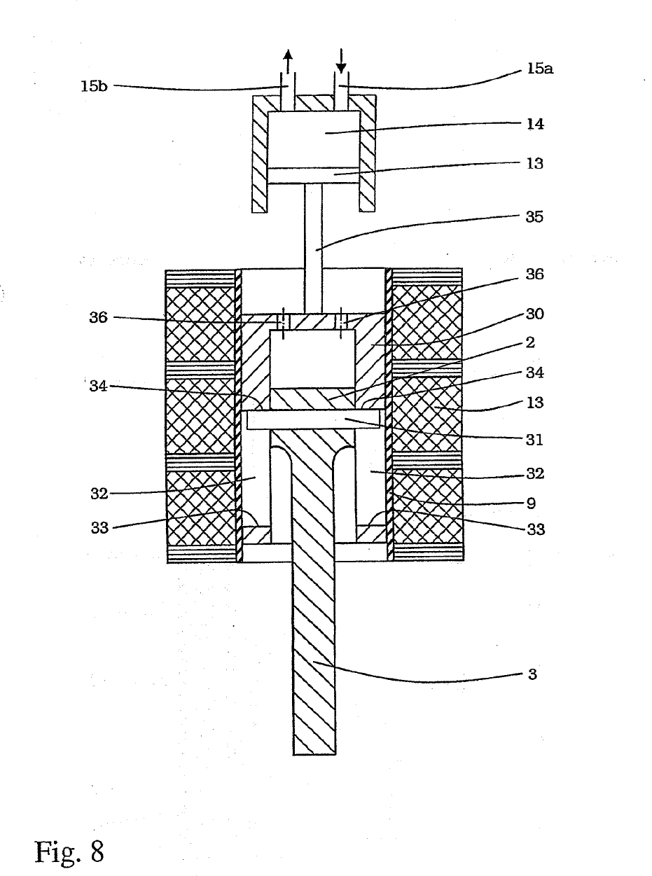

FIG. 8 shows a section through a schematic representation of a percussion mechanism according to an eighth specific embodiment of the present invention in which the percussion mechanism, like that shown in the specific embodiment of FIG. 7, is not realized as a pneumatic spring hammer mechanism. However, in contrast to the specific embodiment shown in FIG. 7, pump piston 13 is positively coupled to drive unit 30, as is shown for example in FIGS. 1 to 6. As a coupling device for transmitting the drive movement of drive unit 30 to percussion piston 3, however, the solution shown in FIG. 7 is used.

In order to prevent an undesired air spring from forming above piston head 2 of percussion piston 3, through-holes 36 are provided in drive unit 30. Through-holes 36 are shown only schematically in FIG. 8. They should have the largest possible cross-sections so that air can flow through them unhindered, with no noticeable air resistance. Of course, other constructions are also conceivable by which drive unit 30 can be connected to pump piston 13. If, however, for this purpose a system similar to that shown in FIGS. 1 to 6 is selected, in the eighth specific embodiment of the present invention care is to be taken that no air spring actually forms between drive unit 30 and percussion piston 3.

1. A boring and/or percussion hammer, comprising:
an electrodynamic linear drive;
a percussion mechanism that has a drive element that can be moved back and forth by the linear drive, a percussion element that can be moved relative to the drive element, and a coupling device that acts between the drive element and the percussion element, and via which the movement of the drive element can be transmitted to the percussion element;
an air-conveying device that has a pump element that can be moved linearly back and forth in order to produce an air flow, wherein
the pump element is coupled to the drive element in such a way that the movement of the drive element is capable of being transmitted to the pump element.

2. The boring and/or percussion hammer as recited in claim 1, wherein the drive element is connected to a runner of the linear drive.

3. The boring and/or percussion hammer as recited in claim 1, wherein the drive element bears the runner or is essentially formed completely by the runner.

4. The boring and/or percussion hammer as recited in claim 1, wherein the coupling device has at least one stop that acts between the drive element and the percussion element.

5. The boring and/or percussion hammer as recited in claim 1, wherein the coupling device has an elastic element that acts in at least one direction between the drive element and the percussion element.

6. The boring and/or percussion hammer as recited in claim 1, wherein the drive element, the runner, and the pump element are connected to one another in one piece to form a constructive unit.

7. The boring and/or percussion hammer as recited in claim 1, wherein the movement of the drive element can be transmitted to the pump element via a mechanical, hydraulic, or pneumatic coupling.

8. The boring and/or percussion hammer as recited in claim 7, wherein the pump element is situated in an area of the boring and/or percussion hammer that is vibrationally decoupled from the percussion mechanism.

9. The boring and/or percussion hammer as recited in claim 1, wherein the runner is essentially cylindrical or hollow-cylindrical.

10. The boring and/or percussion hammer as recited in claim 1, wherein the runner has at least one plate-shaped element that extends in the axial direction.

11. The boring and/or percussion hammer as recited in claim 1, wherein
the air-conveying device has a pump chamber and an air duct;
the pump element is capable of being moved back and forth in the pump chamber; and wherein
the pump chamber can be brought into connection, at least at times, with the surrounding environment via the air duct.

12. The boring and/or percussion hammer as recited in claim 11, wherein the air duct is situated in such a way that it runs past a part of a stator of the linear drive.

13. The boring and/or percussion hammer as recited in claim 11, wherein the air duct has an intake duct so that air can flow from the surrounding environment into the pump chambers.

14. The boring and/or percussion hammer as recited in claim 11, wherein the air duct has an outlet duct so that air can flow from the pump chamber to the surrounding environment.

15. The boring and/or percussion hammer as recited in claim 13, wherein a check valve is situated in at least one of the intake duct and in the outlet duct.

16. The boring and/or percussion hammer as recited in claim 14, wherein a storage device stands in communicating connection with the outlet duct in order to intermediately store at least a part of the air flowing out via the outlet duct.

17. The boring and/or percussion hammer as recited in claim 16, wherein a cross-section of the outlet duct downstream from the storage device is smaller than a cross-section of the outlet duct upstream from the storage device.

18. The boring and/or percussion hammer as recited in claim 16, wherein, during a return movement of the drive element, the storage device can be filled, and, during a striking movement, it can be emptied.

19. The boring and/or percussion hammer as recited in claim 16, wherein a check valve is situated in the outlet duct between the pump chamber and the storage device.

20. The boring and/or percussion hammer as recited in claim 1, rein seen in the striking direction, the pump element is situated behind the drive element and the runner, or next to the percussion mechanism.

21. The boring and/or percussion hammer as recited in claim 1, wherein,
the percussion mechanism is a pneumatic spring hammer mechanism;
the drive element is a drive piston;
the percussion element is a percussion piston; and wherein
the coupling device has an air spring formed in a hollow space between the drive piston and the percussion piston.

22. The boring and/or percussion hammer as recited in claim 21, wherein a cross-sectional surface of the pump element is flow is greater than a cross-sectional surface of the drive piston that acts on the air spring.

23. The boring and/or percussion hammer as recited in claim 21, wherein seen in the striking direction, the drive piston surrounds the percussion piston before and after the percussion piston, in such a way that the air spring is situated behind the percussion piston, and wherein a second air spring can be formed in front of the percussion piston, between the drive piston and the percussion piston.
